(19) United States
(12) Patent Application Publication
(10) Pub. No.: US 2002/0192122 A1
(43) Pub. Date: Dec. 19, 2002

(54) Mosquito fumigator

(76) Inventor: Seung-ho Tak, Seoul (KR)

Correspondence Address: LEYDIG VOIT & MAYER, LTD, 700 THIRTEENTH ST. NW, SUITE 300, WASHINGTON, DC, 20005-3960, US

(21) Appl. No.: 10/169,137

(22) PCT Filed: Dec. 27, 2000
(86) PCT No.: PCT/KR00/01539

(30) Foreign Application Priority Data
Dec. 31, 1999 (KR) 1999/67808

(51) Int. Cl. B32B 5/02; A62B 7/08

(52) U.S. Cl. 422/120; 422/123; 422/125

(57) ABSTRACT

A mosquito fumigator is provided. The mosquito fumigator includes a heating device, having a first substance and a second substance causing a chemical exothermic reaction separately disposed in a closed space of a case, configured such that heat generated by the reaction of the first and second substances is transferred to a radiation plate positioned on the case to heat a mosquito coil placed on the radiation plate, and an operating pin causing the reaction between the first and second substances inside the heating device. The mosquito fumigator heats and fumigates existing electric mosquito coils using heat generated by an exothermic reaction of chemical substances without a separate power supply, and is advantageously used outdoors.

### TECHNICAL FIELD

The present invention relates to a mosquito fumigator, and more particularly, to a mosquito fumigator for fumigating a mosquito coil using heat produced by a chemical exothermic reaction, without using a conventional electric heating device.

### BACKGROUND ART

A conventional mosquito fumigator, as shown in FIG. 1A, immobilizes pests, e.g., mosquitos, by fumes produced when a mosquito coil is burned. According to this method, a mosquito coil 1 is mounted on a mosquito coil stand 2 and then flame is directly applied to the mosquito coil 1 for ignition, so that the mosquito coil 1 is continuously burned by the ignition heat. However, according to this method, even if the mosquito is repelled or immobilized by fumes, a user may suffer from respiration difficulty in closed environments filled with the fumes. Also, since direct ignition is adopted, there is a risk of a fire. Further, the area where the mosquito coil 1 is placed, may be made unclean due to ashes from the burnt mosquito coil 1.

Another example of mosquito fumigators is an electric mosquito fumigator 30, which is widely used. As shown in FIG. 1B, the electric mosquito fumigator 30 is configured such that a mosquito coil 6 is placed on a heating plate 8 which is heated-by electricity supplied through an electric wire 4 and then the mosquito coil 6 is slowly heated to produce vapor which offends pests such as mosquitoes. The produced vapor smells but is barely visible. However, since such a device utilizes electricity as a heat source, it is restrictively used outdoors, that is, in those places which are not provided with electric power.

### DISCLOSURE OF THE INVENTION

To solve the above problems, it is an object of the present invention to provide a mosquito fumigator for heating a mosquito coil using heat by a chemical exothermic reaction without power supply.

Accordingly, to achieve the above object, there is provided a mosquito fumigator including a heating device, having a first substance and a second substance causing a chemical exothermic reaction separately disposed in a closed space of a case, configured such that heat generated by the reaction of the first and second substances is transferred to a radiation plate positioned on the case to heat a mosquito coil placed on the radiation plate, and an operating pin causing the reaction between the first and second substances inside the heating device.

In one aspect of the present invention, the inside of the case of the heating device may be divided into two chambers by the operating pin, and the chemical reaction between the first and second substances is triggered by removing the operating pin.

In another aspect of the present invention, the inside of the case of the heating device is divided into two chambers by a central wall, the central wall has one or more holes, and the operating pin opens/closes the holes.

Preferably, a check valve is formed at a portion of the case for outwardly discharging excessive pressure during the chemical exothermic reaction.

A plurality of exothermic reaction retardant partitions are preferably formed inside the case so that the chemical exothermic reaction takes place slowly.

Preferably, one of the first and second substances is halogen acid, Group IA, IIA and IIIA element containing alkali or Group IA, IIA and IIIA element containing salt, and the other is an oxidizer which reacts the acid, alkali or salt to generate heat.

### BRIEF DESCRIPTION OF THE DRAWINGS

FIGS. 1A and 1B are perspective views illustrating conventional mosquito fumigators;

FIG. 2 is a schematic side view illustrating a mosquito fumigator according to an embodiment of the present invention;

FIG. 3 is a side view illustrating a heat radiating state when an operating pin shown in FIG. 2 is removed;

FIG. 4 is a detailed diagram illustrating an example of a flame chamber having an exothermic reaction retardant partition shown in FIG. 2;

FIG. 5 is a side view of another example of an operating pin shown in FIG. 2;

FIG. 6 is a side view of still another example of an operating pin shown in FIG. 2; and

FIG. 7 is a schematic side view illustrating a mosquito fumigator according to another embodiment of the present invention.

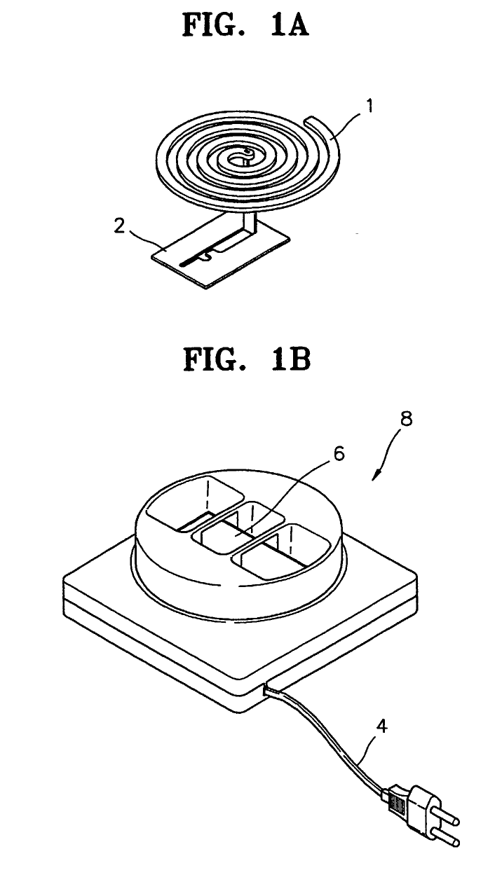

### BEST MODE FOR CARRYING OUT THE INVENTION

The structures and operations of mosquito fumigators according to preferred embodiments of the present invention will now be described with reference to the accompanying drawings.

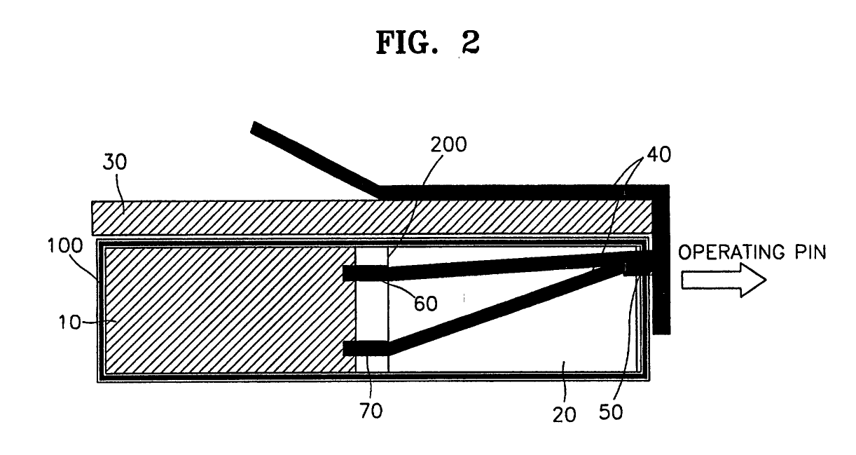

FIG. 2 is a schematic side view illustrating a mosquito fumigator according to an embodiment of the present invention. The mosquito fumigator according to an embodiment of the present invention includes a heating device, surrounded by a case 100, having a first substance 10 and a second substance 20 to trigger a chemical exothermic reaction to heat a radiation plate 30 positioned on the case 100, and an operating pin 40 causing chemical reaction of the chemical substances 10 and 20 inside the heating device.

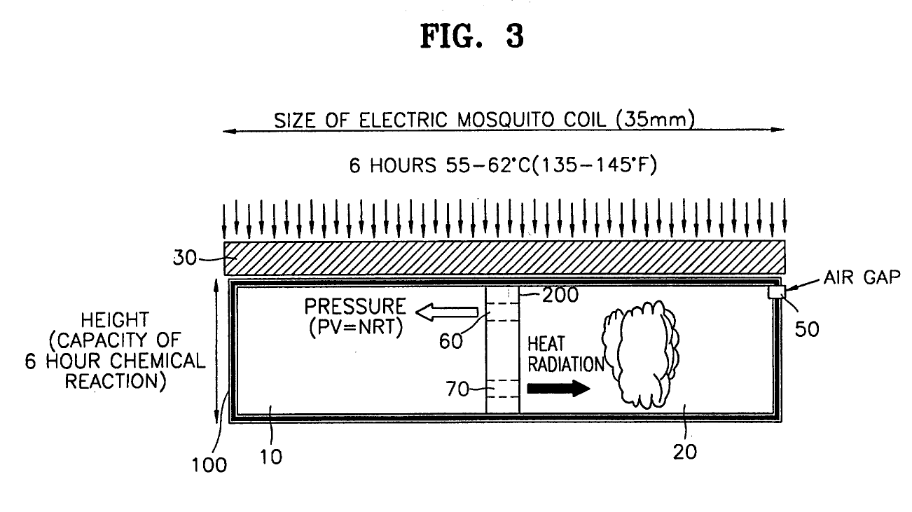

FIG. 3 is a side view illustrating a heat radiating state when an operating pin shown in FIG. 2 is removed. The operation of the mosquito fumigator according to the present invention will be described with reference to FIG. 3. The heating device includes the first substance 10 and the second substance 20 separately placed in the closed space of the case 100 and is configured such that the first substance 10 and the second substance 20 react with each other by removing the operating pin 40, and heat produced by the reaction is transferred to the radiation plate 30 on the case 100 to heat a mosquito coil placed thereon.

According to an aspect of the present invention, the first substance 10 and the second substance 20 are separate from each other by a central wall 200 disposed inside the case 100. Each one or more holes 60 and 70 are formed in the upper and lower portions of the central wall 200. When the mosquito fumigator of the present invention is not in use, the holes 60 and 70 are stopped up by the operating pin 40. When the mosquito fumigator of the present invention is to be used, the operating pin 40 is removed to open the holes 60 and 70. Thus, the separate first and second substances 10 and 20 react with each other.

The operating pin 40 protrudes outside the case 100 while it stops up the holes 60 and 70 formed on the central wall 200 and an air gap 50 formed at a portion of the case 100. When the mosquito fumigator of the present invention is to be used, the operating pin 40 is pulled to remove the same so that the mosquito fumigator operates. The operating pin 40 is a long band-like tape made of metal or plastic, preferably a material which does not react on the first and second substances 10 and 20.

FIG. 5 is a side view of another example of an operating pin shown in FIG. 2. According to another aspect of the present invention, as shown in FIG. 5, the mosquito fumigator may be configured such that an operating pin 42 is installed parallel to a central wall 200 to seal the holes 60 and 70 so that the first and second substances 10 and 20 react with each other by vertically pulling the operating pin 42 to remove the same.

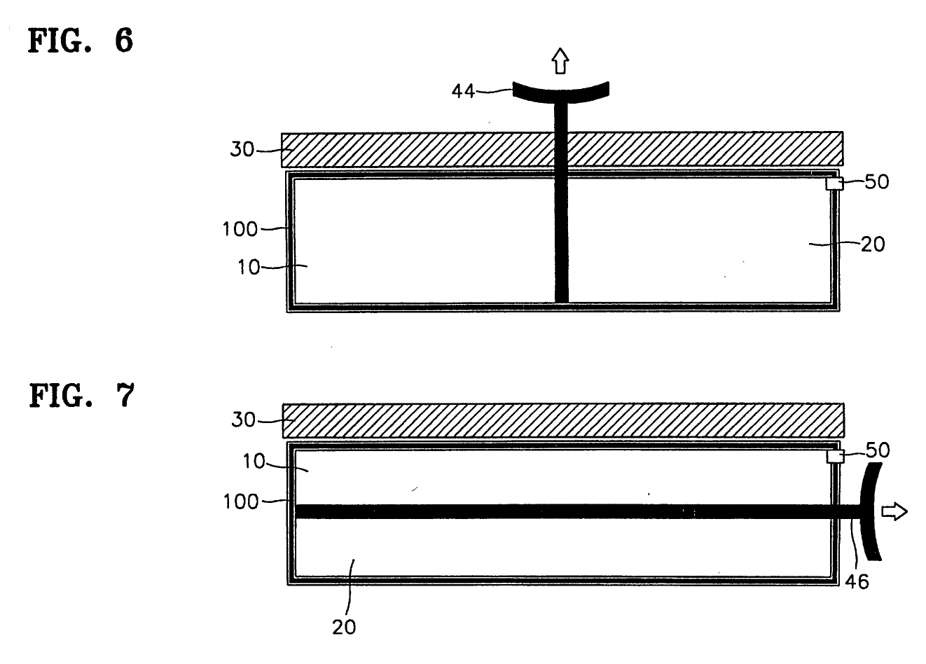

FIG. 6 is a side view of still another example of an operating pin shown in FIG. 2. As shown in FIG. 6, the inside of the case 100 of the heating device is partitioned into two chambers by an operating pin 44, rather than the central wall 200 shown in FIG. 2, and a chemical reaction between the first substance 10 and the second substance 20 is triggered by removing the operating pin 44.

FIG. 7 is a schematic side view illustrating a mosquito fumigator according to another embodiment of the present invention. As shown in FIG. 7, the mosquito fumigator may be configured such that an operating pin 46 is installed in a direction parallel to the bottom and upper surfaces of the case 100 for the first substance 10 and the second substance 20 to be separated from each other up and down.

In order to outwardly discharge excessive pressure during a chemical exothermic reaction, the mosquito fumigator of the present invention has a check valve 50 serving as an air gap at a portion of the case 100. Thus, in the event where excessive pressure is generated by the chemical reaction inside the case 100, the excessive pressure is discharged outwardly. Instead of the check valve 50, a simple air gap for preventing explosion may be installed.

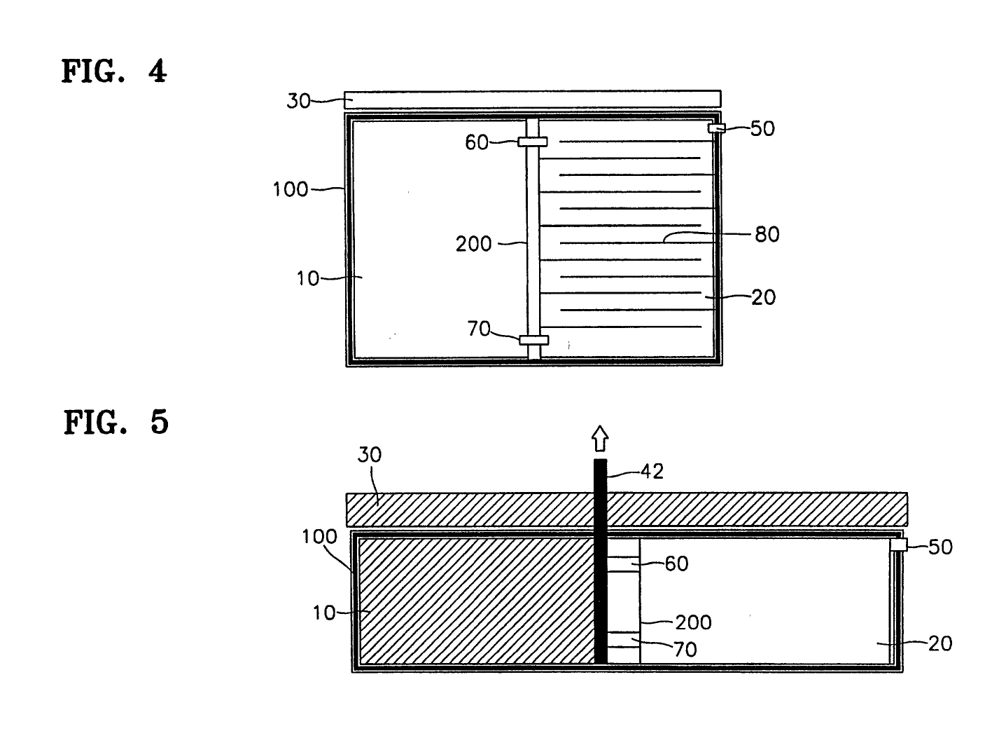

FIG. 4 is a detailed diagram illustrating an example of a flame chamber having exothermic reaction retardant partitions, shown in FIG. 2. As shown in FIG. 4, a mosquito fumigator according to the present invention includes a plurality of exothermic reaction retardant partitions 80 in the flame chamber inside the case 100 so that a chemical exothermic reaction takes place slowly. Although it is shown in FIG. 4 that the partitions 80 are provided only inside the flame chamber, the partitions 80 may be formed through the case 1 00. Also, in order to regulate the rate of the exothermic reaction, a catalyst may be added.

The first and second substances used in the present invention may be any materials that when reacted with each other can be maintained at so high a temperature as to heat a mosquito coil, that is, at 55 to 62° C. (135 to 145° F.) for approximately 6 hours. Preferably, one of the first and second substances is halogen acid, Group IA, IIA and IIIA element containing alkali or Group IA, IIA and IIIA element containing salt, and the other is an oxidizer which reacts the acid, alkali or salt to generate heat. Examples of the acid, alkali or salt include HF, HCl, HBr, Hl, LiOH, NaOH, KOH, MgCl₂, Mg(OH)₂, Ca(OH)₂, CaCl₂, Ca₂CO₃, Al₂(OH)₃, NaHCO₃ and the like.

The oxidizer used herein can be any material that can react with the acid, alkali or salt to trigger an exothermic reaction, but not specifically limited. Preferred examples of the oxidizer include a manganese compound such as KMnO₄, MnO₂ or Mn(CH₃CO₂)₃, a chromium compound such as CrO₃ or Na₂Cr₂O₇, a lead compound such as PbO, PbO₂, Pb(CH₃CO₂)₄, a mercury compound such as HgO, Hg(CH₃CO₂)₂, other metallic compound such as AgO, Ag₂O, AgNO₃, CuCl₂, Cu(CH₃CO₂)₃, FeCl₃, Fe₂(SO₄)₃, Ce(HSO₄)₄, NaBiO₃, PdCl₂ or NiO₂, a halogen compound such as Cl₂, Br₂, 12, NaClO, KBrO₃ or KlO₄, an inorganic nitrogen compound such as HNO₃, HNO₂, N₂O₃ or N₂O₄, a peroxide such as H₂O₂, Na₂O₂ or (C₆H₅CO)₂O₂, an organic compound such as a carbonyl-group compound or a nitro-group containing compound, and water, more preferably water.

A chemical exothermic reaction applied to the present invention will now be described by way of example of water and sodium hydrocarbonate with reference to FIG. 3.

[Reaction Mechanism]

n₁H₂O+n₂NaHCO₃→n₃NaOH+n₄CO₂+Ht+Pr

wherein n₁ through n₄ represent relative constant values of the reaction mechanism, and Ht and Pr represent heat and pressure produced by the reaction, respectively.

In other words, in FIG. 3, if the operating pin 40 is removed, the first substance 10 is mixed with the second substance 20 through the hole 70 formed on the central wall 200 to cause a chemical reaction. The heat produced by the reaction is transferred to the heat radiation plate 30 formed on the case 100, and the pressure produced by the reaction presses the first substance 10 through the hole 60 so that the first substance 10 is smoothly mixed with the second substance 20 to continuously cause an exothermic reaction.

The first and second substances in the above-described embodiments of the present invention may exist in any of solid, liquid and gaseous phases. However, if the reaction takes place at a very low rate, solid phase substances are preferred.

### EXAMPLE 1

50 g of water as the first substance 10 and 80 g of sodium hydrocarbonate as the second substance 20 were put to fabricate a fumigator of FIG. 4, and the operating pin 40 was removed, and then the temperature of the heat radiation plate was measured. The result showed that the temperature was maintained at 58° C. for approximately 6 hours.

### INDUSTRIAL APPLICABILITY

As described above, the mosquito fumigator according to the present invention heats and fumigates existing electric mosquito coils using heat generated by an exothermic reaction of chemical substances without a separate power supply, and is advantageously used outdoors.

What is claimed is:

1. A mosquito fumigator comprising:
a heating device, having a first substance and a second substance causing a chemical exothermic reaction separately disposed in a closed space of a case, configured such that heat generated by the reaction of the first and second substances is transferred to a radiation plate positioned on the case to heat a mosquito coil placed on the radiation plate; and
an operating pin causing the reaction between the first and second substances inside the heating device.

2. The mosquito fumigator according to claim 1, wherein the inside of the case of the heating device is divided into two chambers by the operating pin, and the chemical reaction between the first and second substances is triggered by removing the operating pin.

3. The mosquito fumigator according to claim 1, wherein the inside of the case of the heating device is divided into two chambers by a central wall, the central wall has one or more holes, and the operating pin opens/closes the holes.

4. The mosquito fumigator according to any of claims 1 through 3, wherein a check valve is formed at a portion of the case for outwardly discharging excessive pressure during the chemical exothermic reaction.

5. The mosquito fumigator according to any of claims 1 through 3, wherein a plurality of exothermic reaction retardant partitions are formed inside the case so that the chemical exothermic reaction takes place slowly.

6. The mosquito fumigator according to any of claims 1 through 3, wherein one of the first and second substances is halogen acid, Group IA, IIA and IIIA element containing alkali or Group IA, IIA and IIIA element containing salt, and the other is an oxidizer which reacts the acid, alkali or salt to generate heat.

7. The mosquito fumigator according to claim 6, wherein the acid, alkali or salt is at least one selected from the group consisting of HF, HCl, HBr, Hl, LiOH, NaOH, KOH, MgCl₂, Mg(OH)₂, Ca(OH)₂, CaCl₂, Ca₂CO₃, Al₂(OH)₃ and NaHCO₃, and the oxidizer is at least one selected from the group consisting of a manganese compound including KMnO₄, MnO₂ and Mn(CH₃CO₂)₃, a chromium compound including CrO₃ and Na₂Cr₂O₇, a lead compound including PbO, PbO₂ and Pb(CH₃CO₂)₄, a mercury compound including HgO and Hg(CH₃CO₂)₂, other metallic compound including AgO, Ag₂O, AgNO₃, CuCl₂, Cu(CH₃CO₂)₃, FeCl₃, Fe₂(SO₄)₃, Ce(HSO₄)₄, NaBiO₃, PdCl₂ and NiO₂, a halogen compound including Cl₂, Br₂, I₂, NaClO, KBrO₃ and KlO₄, an inorganic nitrogen compound including HNO₃, HNO₂, N₂O₃ and N₂O₄, a peroxide including H₂O₂, Na₂O₂ and (C₆H₅CO)₂O₂, an organic compound including a carbonylgroup containing compound and a nitro-group compound, and water.
